(19) United States
(12) Patent Application Publication
(10) Pub. No.: US 2024/0014420 A1
(43) Pub. Date: Jan. 11, 2024

(54) FUEL CELL FLUID DISCHARGE SYSTEM, A FUEL CELL SYSTEM, AND A METHOD FOR DISCHARGING BYPRODUCTS PRODUCED DURING FUEL CELL OPERATION

(71) Applicant: Teledyne Energy Systems, Inc., Thousand Oaks, CA (US)

(72) Inventors: Thomas I. Valdez, Timonium, MD (US); Robert K. Wynne, New Freedom, PA (US); John F. Borger, York, PA (US); Andrew J. Leanna, Lutherville, MD (US); Brianna M. Warrenfeltz, Middletown, MD (US); Johnny D. Alston, Seven Valleys, PA (US)

(21) Appl. No.: 17/810,916

(22) Filed: Jul. 6, 2022

(51) Int. Cl. H01M 8/04119; H01M 8/04082

(52) U.S. Cl. CPC H01M 8/04179; H01M 8/04201

(57) ABSTRACT

A fuel cell fluid discharge system, a fuel cell system, and a method for discharging byproducts produced during fuel cell operation are provided. The fluid discharge system comprises an inlet port, a discharge port, and a vessel. The vessel comprises a vessel port and an adjustable wall. The adjustable wall forms a fluid tight seal between a first volume within the vessel partially bounded by a first side of the adjustable wall, and a second volume of the vessel partially bounded by a second side of the adjustable wall. Moving the adjustable wall from a second position to a first position draws fluid through the inlet port into the first volume. Moving the adjustable wall from the first position to the second position expels fluid through the discharge port from the first volume at a pressure greater than a reactant pressure of the fuel cell.

### FIELD OF USE

The present disclosure relates to a fuel cell fluid discharge system, a fuel cell system, and a method for discharging byproducts produced into a high pressure environment.

### BACKGROUND

Fuel cells generally operate by reacting a fuel and an oxidant to produce electricity, heat, and chemical reaction products. For example, fuel cells utilizing hydrogen gas as a fuel and oxygen gas as an oxidant generate electricity, heat, and water. There are challenges with removing chemical reaction products and/or other byproducs from fuel cells in high pressure environments.

### SUMMARY

One non-limiting aspect according to the present disclosure is directed to a fluid discharge system. The system comprises a vessel, an inlet port, and a discharge port. The inlet port is in fluid communication with a fluid source. The vessel comprises a vessel port and an adjustable wall. The adjustable wall forms a fluid tight seal between a first volume within the vessel partially bounded by a first side of the adjustable wall, and a second volume of the vessel partially bounded by a second side of the adjustable wall. The first volume fluidly communicates with the inlet port and the discharge port via the vessel port. The adjustable wall is configured to move between a first position and a second position within the vessel. Moving the adjustable wall from the second position to the first position within the vessel increases a size of the first volume and draws fluid through the inlet port into the first volume. Moving the adjustable wall from the first position to the second position within the vessel decreases the size of the first volume and expels fluid through the discharge port from the first volume at a pressure greater than a pressure in the fluid source.

A further non-limiting aspect according to the present disclosure is directed to a fuel cell system comprising a fuel cell and a fluid discharge system constructed according to the present disclosure in fluid communication with the fuel cell.

Yet another non-limiting aspect according to the present disclosure is a method for discharging byproducts into a high pressure environment. The method comprises enabling fluid communication between the fuel cell and a first volume of a vessel comprising an adjustable wall therein. The first volume within the vessel is partially bounded by the adjustable wall. The method further comprises moving the adjustable wall from a second position to a first position, thereby increasing a size of the first volume and drawing byproducts into the first volume. Subsequent to drawing byproducts into the first volume, fluid communication between the fluid source and the first volume of the vessel is inhibited and fluid communication between the first volume and a discharge port is enabled. The method further comprises moving the adjustable wall from the first position to the second position, thereby reducing the size of the first volume and expelling at least a portion of the byproducts from the first volume through the discharge port at a pressure greater than a pressure of the fluid source.

It will be understood that the inventions disclosed and described herein are not limited to the aspects summarized in this Summary. The reader will appreciate the foregoing details, as well as others, upon considering the following detailed description of various non-limiting and non-exhaustive aspects according to the present disclosure.

### BRIEF DESCRIPTION OF THE DRAWINGS

The features and advantages of the examples presented herein, and the manner of attaining them, will become more apparent, and the examples will be better understood, by reference to the following description taken in conjunction with the accompanying drawings, wherein:

FIG. 1 is a schematic process and instrumentation diagram showing certain elements of a non-limiting embodiment of a fuel cell system according to the present disclosure;

FIG. 2 is a schematic process and instrumentation diagram showing certain elements of a non-limiting embodiment of a fluid discharge system according to the present disclosure, with an adjustable wall in a second position;

FIG. 3 is a schematic process and instrumentation diagram of the fluid discharge system shown in FIG. 2, with the adjustable wall in a first position; and

FIG. 4 is a schematic process and instrumentation diagram showing certain elements of a non-limiting embodiment of a fluid discharge system according to the present disclosure, including a mechanical actuator.

The exemplifications set out herein illustrate certain non-limiting embodiments, in one form, and such exemplifications are not to be construed as limiting the scope of the appended claims and the invention in any manner.

### DETAILED DESCRIPTION OF NON-LIMITING EMBODIMENTS

Various examples are described and illustrated herein to provide an overall understanding of the structure, function, and use of the disclosed systems, apparatus, parts, assemblies, and methods. The various examples described and illustrated herein are non-limiting and non-exhaustive. Thus, the invention is not limited by the description of the various non-limiting and non-exhaustive examples disclosed herein. Features and characteristics illustrated and/or described in connection with various examples herein may be combined with features and characteristics of other examples herein. Such modifications and variations are intended to be included within the scope of the present disclosure. The various non-limiting embodiments disclosed and described in the present disclosure can comprise, consist of, or consist essentially of the features and characteristics as variously described herein.

Any references herein to “various non-limiting embodiments”, “some non-limiting embodiments”, “certain non-limiting embodiments”, “one non-limiting embodiment”, “a non-limiting embodiment”, “an embodiment”, “one embodiment”, or like phrases mean that a particular feature, structure, act, or characteristic described in connection with the example is included in at least one embodiment. Thus, appearances of the phrases “various non-limiting embodiments”, “some non-limiting embodiments”, “certain non-limiting embodiments”, “one non-limiting embodiment”, “a non-limiting embodiment”, “an embodiment”, “one embodiment”, or like phrases in the specification do not necessarily refer to the same non-limiting embodiment. Furthermore, the particular described features, structures, or characteristics may be combined in any suitable manner in one or more non-limiting embodiments. Thus, the particular features, structures, or characteristics illustrated or described in connection with one non-limiting embodiment may be combined, in whole or in part, with the features, structures, or characteristics of one or more other non-limiting embodiments without limitation. Such modifications and variations are intended to be included within the scope of the present non-limiting embodiments.

Typically, a fuel cell can comprise an anode, a cathode, and an electrolyte located between the anode and the cathode. The anode and the cathode are electrically conductive, porous, and may comprise catalysts such as platinum or platinum-based materials supported on carbon nano-particles or micro-particles incorporated into the structure of the anode and the cathode. The catalyst in the anode can promote the oxidation of hydrogen (H₂) into two protons (H⁺) and two electrons (e⁻). The protons produced in the anode transport through the electrolyte to the cathode. The electrolyte can be a non-electrically-conductive Polymer Electrolyte Membrane (PEM) that is permeable to the protons, but is impermeable to the hydrogen and oxygen reactants although other fuel cell chemistries can be substituted in place of PEM. The electrons produced in the anode are collected and form an electrical current that flows from the anode, through an external electrical circuit, and into the cathode. The catalyst in the cathode promotes the reduction of oxygen (O₂) into water by reacting with the protons that transport through the electrolyte membrane from the anode and with the electrons from the external electrical circuit.

Generally, hydrogen gas and oxygen gas can be separately fed to the fuel cell as reactants. The fuel cell can be a continuous flow fuel cell or a closed loop fuel cell. In a continuous flow fuel cell, the hydrogen gas is fed through a fuel inlet and flows through an anode side flow path in contact with the anode. Excess hydrogen gas that does not oxidize to protons and electrons at or in the anode can exit the anode side flow path through an anode outlet. The oxygen gas is fed through an oxidant inlet and flows through a cathode side flow path in contact with the cathode. The water reaction product and excess oxygen gas that does not reduce to water at or in the cathode can exit the cathode outlet. Alternately, a fuel cell can operate in a closed loop without excess reactant flow (e.g., “dead-ended” mode) where excess hydrogen gas and excess oxygen gas are not continuously withdrawn from the fuel cell and, instead, may be removed from the fuel cell during a reactant purge. Closed loop fuel cells can remove excess product water utilizing porous wick structures and/or hydrophilic micro-porous layers that transport water but prevent hydrogen and oxygen reactants from exiting the fuel cell until a reactant purge operation is performed.

Additionally, the reactant gas may comprise impurities/inert gases, which may have to be removed from the fuel cell. In various non-limiting embodiments, the fuel cell can accumulate condensation or other sources of water that have to be removed from the fuel cell.

Fuel cells come in various forms. For example, proton exchange membrane fuel cells, which also are known as polymer electrolyte membrane (PEM) fuel cells, utilize hydrogen as fuel and oxygen as an oxidant to produce electricity, heat, and a chemical reaction product of water. The construction and operation of fuel cells generally, and of PEM fuel cells specifically, is described, for example, in F. Barbir, PEM Fuel Cells: Theory and Practice, Elsevier, 2013, and in J. Zhang, PEM Fuel Cell Electrocatalysts and Catalyst Layers: Fundamentals and Applications, Springer, 2008, which are both incorporated herein by reference in their entireties.

When a fuel cell operates in an environment at atmospheric pressure (e.g., 1 atmosphere absolute), produced water, excess gas reactants, impurities/inert gases, and/or other byproducts can be expelled into the environment because the reactant pressure in the fuel cell is generally higher than the atmospheric pressure. When a fuel cell operates in a subsea environment and/or a downhole environment (e.g., in a gas well, an oil well, or a geothermal well), the environmental pressure can exceed the reactant pressure. This pressure difference can make expelling the produced water, excess gas reactants, impurities/inert gases, and/or other byproducts from the fuel cell into the environment difficult. Earlier-filed patent applications have focused on storing the produced water, excess gas reactants, impurities/inert gases, and/or other byproducts until such time as they can be removed from the fuel cell. Additionally, a mixture comprising the produced water, excess gas reactants, impurities/inert gases, and/or other byproducts can comprise compressible fluids that can require a large amount of energy to directly pump out of the fuel cell.

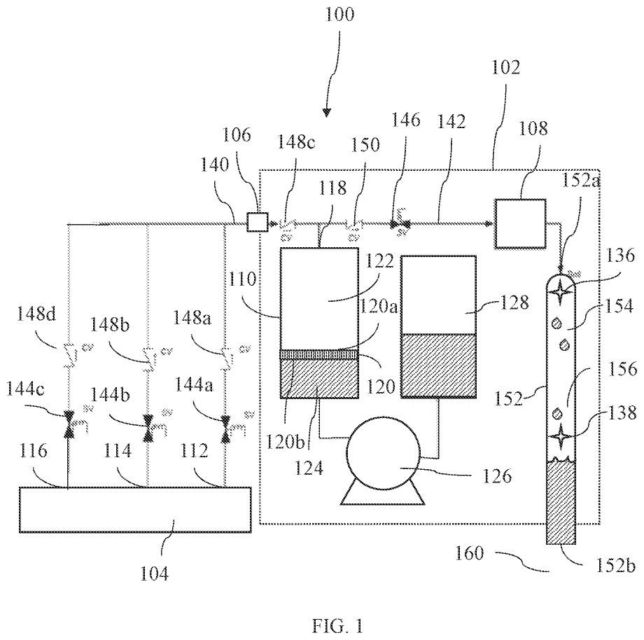

In order to address the foregoing issues, the present inventors have developed a fluid discharge system, a fuel cell system, and method for discharging byproducts into a high pressure environment according to the present disclosure. For ease of clarify, the fluid discharge system and method for discharging byproducts will be described in terms of a fuel cell system but it would be understood, the fluid discharge system and method for discharging byproducts could include or be replaced by or additionally include other types of systems, such as, for example, a ballast compensation system for Autonomous Underwater Vehicles (AUVs). FIG. 1 illustrates a non-limiting embodiment of a fuel cell system 100 comprising a fuel cell 104 and a fluid discharge system 102 in fluid communication with the fuel cell 104. The fuel cell system 100 can be configured to operate in a subsea environment and/or a downhole environment. For example, the fuel cell system 100 can comprise materials and have a construction suitable to withstand corrosive environments and/or a high pressure environment.

As used herein, “a high pressure environment” means an environment in which the pressure is greater than a pressure at which the fuel (e.g., hydrogen gas) and oxidant (e.g., oxygen gas) are reacted within the fuel cell (e.g., reactant pressures internal to the fuel cell). In various embodiments, a high pressure environment may comprise a pressure that is, for example, at least 50 pounds per square inch absolute (PSIA), such as, for example, at least 100 PSIA, at least 1,000 PSIA, at least 1,500 PSIA, at least 3,000 PSIA, at least 5,000 PSIA, or at least 10,000 PSIA. For example, the high pressure environment can comprise a pressure in a range of 50 PSIA to 10,000 PSIA, such as, for example, 50 PSIA to 5,000 PSIA, 500 PSIA to 3,000 PSIA, or 500 PSIA to 1,500 PSIA. In various non-limiting embodiments, the fuel cell system 100 is configured to operate in a subsea environment at an underwater depth at least 1,000 meters and with an external pressure of 1,500 PSIA.

The fuel cell 104 can be a fuel cell as described herein, such as, for example, a PEM fuel cell. The fuel cell 104 can be in fluid communication with a hydrogen gas source and an oxygen gas source. The fuel cell 104 can be configured to generate heat, electricity, and water. The fuel cell can comprise an anode outlet 112, a cathode outlet 114, and a water source outlet 116. For example, excess hydrogen gas that does not oxidize to protons and electrons at or in an anode of the fuel cell 104 can exit the fuel cell 104 through the anode outlet 112, and excess oxygen gas that does not reduce to water at or in a cathode of the fuel cell 104 can exit the fuel cell 104 through the cathode outlet 114. In various non-limiting embodiments, water produced by the fuel cell 104 can exit the fuel cell 104 through the cathode outlet 114 or the water source outlet 116. In various non-limiting embodiments, the water source outlet 116 can serve as an exit from the fuel cell 104 for at least one of water produced by the fuel cell 104, environmental water produced through condensation within a cavity of the fuel cell 104, water produced in a secondary process of the fuel cell 104, and other water that may need to be removed from the fuel cell 104.

The fluid discharge system 102 comprises an inlet port 106, a discharge port 108, and a vessel 110. The inlet port 106 can be in fluid communication with a fluid source such as, for example, one or more of the anode outlet 112, the cathode outlet 114, and the water source outlet 116. The discharge port 108 can be in fluid communication with an external environment 160. The external environment 160 can be a high pressure environment, such as, for example, a subsea environment and/or a downhole environment.

The vessel 110 can comprise a vessel port 118 and a first fluid conduit 140 can connect the vessel port 118 and the respective fluid source via inlet port 106. In various non-limiting embodiments, the first fluid conduit 140 can comprise a flow valve 144a, a flow valve 144b, and a flow valve 144c configured to control fluid communication between the vessel port 118 and the respective fluid source. For example, the flow valve 144a can control fluid communication between the anode outlet 112 and the vessel port 118. The flow valve 144b can control fluid communication between the cathode outlet 114 and the vessel port 118. The flow valve 144c can control fluid communication between the water source outlet 116 and the vessel port 118. In various non-limiting embodiments, the first fluid conduit 140 can comprise a check valve 148a, a check valve 148b, a check valve 148c, and a check valve 148d, which all can be configured to inhibit fluid flow from the vessel port 118 to the respective fluid source. For example, the check valve 148a can inhibit backflow into the anode outlet 112, the check valve 148b can inhibit backflow into the cathode outlet 114, the check valve 148c can inhibit backflow into the inlet port 106, and the check valve 148d can inhibit backflow into the water source outlet 116.

A second fluid conduit 142 can connect the vessel port 118 and the discharge port 108. The second fluid conduit 142 can comprise a second flow valve 146 configured to control fluid communication between the vessel port 118 and the discharge port 108. In various non-limiting embodiments, the second fluid conduit 142 can comprise a check valve 150 configured to inhibit fluid flow from the discharge port 108 to the vessel port 118.

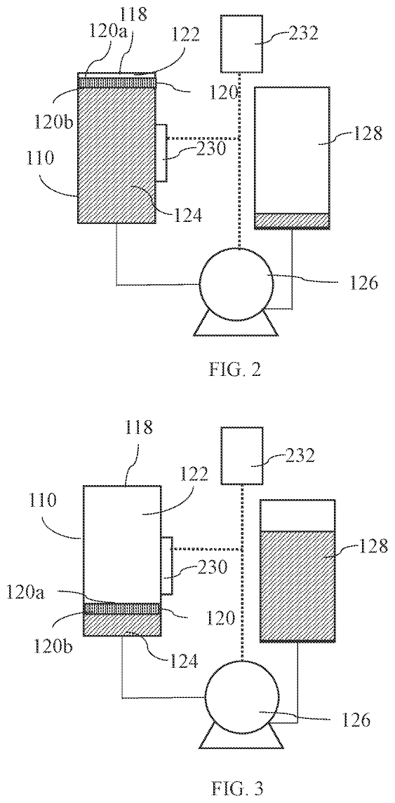

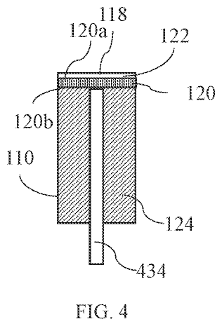

In various non-limiting embodiments, the flow valve 144a, the flow valve 144b, the flow valve 144c, and/or the flow valve 146 can be a solenoid valve. Each flow valve 144a, 144b, 144c, and 146 can be in signal communication with a controller (e.g., controller 232 shown in FIG. 2 and FIG. 3). The controller 232 can change a state of each flow valve 144a, 144b, 144c, and 146. For example, the controller 232 can configure, individually, the respective flow valve 144a, 144b, 144c, and 146 into a closed state wherein fluid flow is inhibited through the respective flow valve 144a, 144b, 144c, and 146, or into an open state wherein fluid flow is enabled through the respective flow valve 144a, 144b, 144c, and/or 146.

The vessel 110 can be configured to received fluids from the inlet port 106 and expel the fluids through the discharge port 108. For example, the vessel 110 can comprise an adjustable wall 120 configured to facilitate movement of fluids in the fluid discharge system 102. The adjustable wall 120 can comprise at least one of a bellows, a diaphragm, a bladder, and a piston. In various non-limiting embodiments, the vessel 110 can be configured to withstand a corrosive environment and/or a high pressure environment. For example, the vessel 110 can comprise a material or materials suitable to withstand a corrosive environment and/or a high pressure environment, such as, for example, stainless steel, a nickel-chromium superalloy (e.g., an INCONEL alloy), and/or other material.

The adjustable wall 120 can form a fluid tight seal between a first volume 122 within the vessel 110 partially bounded by a first side 120a of the adjustable wall 120, and a second volume 124 of the vessel 110 partially bounded by a second side 120b of the adjustable wall 120. The first volume 122 fluidly communicates with the inlet port 106 and the discharge port 108 via the vessel port 118. The vessel port 118 can be a single opening or at least two openings. In various non-limiting embodiments wherein the vessel port 118 comprises at least two openings, a first opening can fluidly communicate with the inlet port 106 and a second opening can fluidly communicate with the discharge port 108.

The adjustable wall 120 can be configured to move between a first position within the vessel 110, as illustrated in FIG. 2, and a second position within the vessel 110, as illustrated in FIG. 3, and positions therebetween. Moving the adjustable wall 120 from the second position illustrated in FIG. 2 to the first position illustrated in FIG. 3 increases a size of the first volume 122 and can draw fluid through the inlet port 106 into the first volume 122. For example, increasing the size of the first volume 122, while inhibiting backflow from the discharge port 108 (e.g., by check valve 150 and/or flow valve 146) and enabling fluid communication between the vessel port 118 and the anode outlet 112, the cathode outlet 114, and/or the water source outlet 116, can create a pressure differential between the anode outlet 112, the cathode outlet 114, and/or water source outlet 116, and the first volume 122. The first volume 122 is an area of lower pressure. The lowered pressure within the first volume 122 draws fluid from the anode outlet 112, the cathode outlet 114, and/or the water source outlet 116 into the first volume 122. The fluid drawn into the first volume 122 can comprise a mixture of compressible fluids (e.g., hydrogen gas, oxygen gas, impurities/inert gas) and non-compressible fluid (e.g., liquid water). The first volume 122 can be increased at a desired rate and/or to a desired volume to facilitate movement of fluid from the fuel cell 104 to the external environment 160 at a desired rate. In various non-limiting embodiments, a time period for the adjustable wall 120 to move between the first position and the second position can be in a range of 1 second to 1 hour. In certain non-limiting embodiments, the sum of the first volume 122 and the second volume 124 can be in a range of 10 mL to 1000 liters.

Moving the adjustable wall 120 from the first position illustrated in FIG. 3 to the second position illustrated in FIG. 2 decreases the size of the first volume 122 and can expel fluid through the discharge port 108 to the external environment 160 from the first volume 122 at a pressure greater than a high pressure environment. For example, decreasing the size of the first volume 122, while inhibiting backflow into the inlet port 106 (e.g., by check valve 148a, 148b, 148c, and/or 148d, and/or flow valve 144a, 144b, and/or 144c) and enabling fluid communication between the vessel port 118 and the discharge port 108, can create a pressure differential between the first volume 122 and the external environment 160 wherein the first volume 122 is a region of higher pressure. The higher pressure of the first volume 122 urges fluid from the first volume 122 into the external environment 160 via the discharge port 108.

All of the fluid present in the first volume 122 can be expelled from the first volume 122, or less than all of the fluid present in the first volume 122 can be expelled from the first volume 122. For example, a predetermined volume of a non-compressible fluid (e.g., water) can be maintained in the first volume 122 during movement of the adjustable wall 120 between the first position illustrated in FIG. 3 and the second position illustrated in FIG. 2. Maintaining non-compressible fluid in the first volume 122 can increase the efficiency of the fluid discharge system 102 by eliminating substantially all compressible fluids from the first volume 122. Leaving compressible fluid (e.g., gas) in the first volume 122 can diminish efficiency of the fuel cell system 100 because of the compressibility of the fluid. Moving the adjustable wall 120 from the first position to the second position may be a small volumetric change and thus, urging compressible fluids beyond check valve 150 while expelling fluids can increase efficiency of the fuel cell system 100.

During operation, the vessel 110 can be oriented such that a portion of compressible fluid (e.g., a gas) present in the first volume 122 can be expelled through the vessel port 118 prior to expelling a portion of a non-compressible fluid in the first volume 122. For example, the vessel 110 can be oriented such that gravity urges the non-compressible fluid away from the vessel port 118.

The adjustable wall 120 can be moved by various methods, such as, for example, introduction of non-compressible fluid and/or removal of non-compressible fluid from the second volume 124, as shown in FIGS. 2 and 3, and/or by means of a mechanical actuator 434, as shown in FIG. 4.

Referring to FIGS. 1-3, the fluid discharge system 102 can comprise a hydraulic pump 126 in fluid communication with the second volume 124 and a fluid reservoir 128 in fluid communication with the hydraulic pump 126. The fluid reservoir 128 can comprise a bellows, a bladder (e.g., sealed bladder, vented bladder), a rigid vessel, and/or other vessel type. In various non-limiting embodiments, the non-compressible fluid used in the hydraulic pump 126 and the fluid reservoir 128 comprises a hydraulic liquid (e.g., oil).

The hydraulic pump 126 can transfer non-compressible fluid from the fluid reservoir 128 to the second volume 124. Introduction of non-compressible fluid into the second volume 124 can move the adjustable wall from the first position shown in FIG. 3 to the second position shown in FIG. 2. The hydraulic pump 126 can be configured to provide the non-compressible fluid to the second volume 124 at a pressure greater than a high pressure environment such that the adjustable wall 120 moves and the pressure in the first volume 122 increases to a pressure greater than a high pressure environment. Introduction of a non-compressible fluid into the second volume 124 can increase the pressure in the second volume 124 and move the adjustable wall 120 until pressures within the first volume 122 and the second volume 124 are substantially equal. For example, the adjustable wall 120 may move until a pressure differential between fluid in the first volume 122 and fluid in the second volume 124 is no greater than 100 PSI, such as, for example, no greater than 70 PSI, no greater than 50 PSI, no greater than 40 PSI, no greater than 20 PSI, no greater than 10 PSI, no greater than 2 PSI, or no greater than 1 PSI.

The hydraulic pump 126 can transfer non-compressible fluid from the second volume 124 to the fluid reservoir 128. For example, the hydraulic pump 126 can be configured to remove at least a portion of the non-compressible fluid from the second volume 124 to move the adjustable wall 120 from the second position illustrated in FIG. 2 to the first position illustrated in FIG. 3. The direction of the fluid flow between the second volume 124 and the fluid reservoir 128 can be changed through valves and/or reversal of the hydraulic pump 126. Because the hydraulic pump 126 encounters substantially only a non-compressible fluid, the hydraulic pump 126 can be smaller and more electrically efficient than a pump that directly handles both compressible and non-compressible fluids. Thus, the size and electrical requirements of the hydraulic pump 126 can be reduced, increasing the overall efficiency of the fuel cell system 100.

In various non-limiting embodiments, the fluid reservoir 128 can be configured as vessel 110 so that one of the vessel 110 and the fluid reservoir 128 is actively expelling fluids through the discharge port 108 while the other is receiving fluids during movement of the respective adjustable wall 120 in the vessel 110 and the fluid reservoir 128. In certain non-limiting embodiments, different fluid sources may be connected the vessel 110 and the fluid reservoir 128. For example, the anode outlet 112 can be in fluid communication with one of the vessel 110 and the fluid reservoir 128 and the other can be in fluid communication with the cathode outlet 114 and the water source outlet 116.

Alternatively, in various non-limiting embodiments wherein a mechanical actuator 434 is used to move the adjustable wall 120, as shown in FIG. 4, a pressure differential between fluid in the first volume 122 and fluid in the second volume 124 can be greater than 100 PSI. In various non-limiting embodiments, the mechanical actuator 434 can comprise a mechanical screw.

Referring to FIGS. 2 and 3, the fluid discharge system 102 can comprise a sensor 230 configured to measure at least one of the position of the adjustable wall 120 and a non-compressible fluid level in the first volume 122. The controller 232 can be in signal communication with the sensor 230 and the hydraulic pump 126. The controller 232 can be configured to adjust a state of the hydraulic pump 126 based on the sensor 230. For example, based on feedback from the sensor 230, the controller 232 can activate the hydraulic pump 126, stop the hydraulic pump 126, adjust a speed of the hydraulic pump 126, and/or adjust a pressure output of the hydraulic pump 126. The controller 232 can comprise hardware circuitry suitable to perform the functions described herein.

Referring again to FIG. 1, the discharge port 108 can comprise an inverted tube 152 (e.g., a bell) defining a tube cavity 154. The inverted tube 152 is in fluid communication with the vessel port 118 and the external environment 160. During operation of the fluid discharge system 102, the inverted tube 152 can be oriented such that a gas barrier 156 is maintained in the tube cavity 154. For example, the inverted tube 152 can be oriented such that gravity urges liquids away from a tube inlet 152a of the inverted tube 152 and gases move towards a tube outlet 152b of the inverted tube 152. The tube outlet 152b can be in direct contact with the external environment 160. The gas barrier 156 can prevent liquids from interacting with the tube inlet 152a. For example, the gas barrier 156 can prevent seawater from contacting portions of the discharge port 108 that may be susceptible to corrosion.

The pressure in the tube cavity 154 can be adjusted to maintain the gas barrier 156 during descent of the fuel cell system 100 into the sea and/or hole. The pressure in the tube cavity 154 can be adjusted by expelling gas from the first volume 122, a separate gas source can be in fluid communication with the discharge port 108, and/or a reactant 138 can be positioned in the tube cavity 154. For example, the reactant 138 can be positioned in the tube cavity 154 intermediate the tube inlet 152a and the tube outlet 152b. The reactant can be configured to generate a gas (e.g., hydrogen, oxygen) when the reactant 138 contacts seawater. For example, the reactant 138 can comprise aluminum powder, and the aluminum powder can generate hydrogen gas when contacting seawater.

In various non-limiting embodiments, the fluid discharge system 102 can be configured to purge a gas from a separate gas source and/or from the first volume 122 (e.g., a gas which came from the anode outlet 112 and/or cathode outlet 114) to maintain the gas barrier 156 in the tube cavity 154. For example, the separate gas source can comprise a pressurized bottle of gas that is configured to release gas at a desired rate and/or time while the fuel cell system 100 is lowered into the sea and/or hole, thus maintaining the gas barrier 156 as the pressure increases in the external environment 160.

In various non-limiting embodiments, the inverted tube further comprises a catalyst 136 positioned in the tube cavity 154 and configured to convert oxygen gas and hydrogen gas to water. The catalyst 136 can minimize at least one of residual hydrogen gas and oxygen gas from the fuel cell 104. The catalyst 136 can comprise a precious metal catalyst, a non-precious metal catalyst, and/or other catalyst. A precious metal catalyst can comprise platinum and/or rhodium. A non-precious metal catalyst can comprise manganese, copper, nickel, cobalt, and/or iron. Other possible catalysts may comprise a nitroxyl oxide, a nitrogen oxide, and/or an iron doped graphitic carbon nitride (e.g., Fe-g-C₃N₄).

The present disclosure also provides a method for discharging byproducts produced during operation of the fuel cell 104. A non-limiting embodiment of the method comprises enabling fluid communication between the fuel cell 104 and the first volume 122. Enabling fluid communication can comprise changing the state of flow valve 144a, 144b, and/or 144c to an open state. Fluid communication may be inhibited between the first volume 122 and the discharge port 108 by changing the state of flow valve 146 to a closed state.

The method comprises moving the adjustable wall 120 from the second position, as illustrated in FIG. 2, to the first position, as illustrated in FIG. 3, thereby increasing a size of the first volume 122 and drawing byproducts produced during operation of the fuel cell 104 into the first volume 122 from the fuel cell 104. After the byproducts are drawn into the first volume 122, fluid communication between the fuel cell 104 and the first volume 122 can be inhibited. For example, the state of flow valve 144a, 144b, and/or 144c can be changed to a closed state and/or the check valve 148c can inhibit backflow. The byproducts can comprise at least one of oxygen gas, hydrogen gas, an impurity/inert gas, and water.

The method further comprises enabling fluid communication between the first volume 122 and the discharge port 108. For example, the state of flow valve 146 can be changed to an open state. The adjustable wall 120 can be moved from the first position, as illustrated in FIG. 3, to the second position, as illustrated in FIG. 2, thereby reducing the size of the first volume 122 and expelling at least a portion of the byproducts from the first volume 122 through the discharge port 108 at a pressure greater than a reactant pressure of the fuel cell.

Various aspects of non-limiting embodiments of an invention according to the present disclosure include, but are not limited to, the aspects listed in the following numbered clauses.
Clause 1. A fluid discharge system, the system comprising:
an inlet port in fluid communication with a fluid source;
a discharge port; and
a vessel comprising a vessel port and an adjustable wall, wherein
   the adjustable wall forms a fluid tight seal between a first volume within the vessel partially bounded by a first side of the adjustable wall, and a second volume of the vessel partially bounded by a second side of the adjustable wall, wherein the first volume fluidly communicates with the inlet port and the discharge port via the vessel port, and
   the adjustable wall is configured to move between a first position and a second position within the vessel, wherein moving the adjustable wall from the second position to the first position within the vessel increases a size of the first volume and draws fluid through the inlet port into the first volume, and wherein moving the adjustable wall from the first position to the second position within the vessel decreases the size of the first volume and expels fluid through the discharge port from the first volume at a pressure greater than a pressure of the fluid source.
Clause 2. The system of clause 1, wherein the adjustable wall comprises at least one of a bellows, a diaphragm, a bladder, and a piston.
Clause 3. The system of any of clauses 1-2, further comprising a hydraulic pump and a fluid reservoir, wherein the hydraulic pump is configured to introduce a non-compressible fluid into the second volume of the vessel to move the adjustable wall from the first position to the second position, and wherein the hydraulic pump also is configured to remove at least a portion of the non-compressible fluid from the second volume of the vessel to move the adjustable wall from the second position to the first position.
Clause 4. The system of clause 3, wherein the hydraulic pump is configured to provide the non-compressible fluid to the second volume at a pressure greater than a reactant pressure of the fuel cell.
Clause 5. The system of any of clauses 3-4, wherein a pressure differential between fluid in the first volume and fluid in the second volume is no greater than 100 pounds per square inch absolute (PSIA).
Clause 6. The system of any of clauses 1-2, further comprising a mechanical actuator configured to move the adjustable wall between the second position and the first position.
Clause 7. The system of any of clauses 3-6, further comprising:
a sensor configured to measure at least one of the position of the adjustable wall and a non-compressible fluid level in the first volume; and
a controller in signal communication with the sensor and the hydraulic pump, the controller configured to adjust a state of the hydraulic pump based on the sensor.
Clause 8. The system of any of clauses 1-7, wherein, during operation, the vessel is oriented such that a portion of gas present in the first volume is expelled through the vessel port prior to expelling a portion of a non-compressible fluid in the first volume.
Clause 9. The system of any of clauses 1-8, wherein a predetermined volume of a non-compressible fluid is maintained in the first volume during movement of the adjustable wall between the first position and the second position.
Clause 10. The system of any of clauses 1-9, wherein the discharge port comprises an inverted tube defining a tube cavity, and wherein, during operation of the system, the inverted tube is oriented such that a gas barrier is maintained in the tube cavity.
Clause 11. The system of clause 10, wherein at least one of a gas expelled from the first volume, a separate gas source in fluid communication with the discharge port, and a reactant positioned in the tube cavity is configured to adjust a pressure in the tube cavity to maintain the gas barrier during descent of the system into a sea and/or a hole.
Clause 12. The system of any of clauses 10-12, wherein the inverted tube further comprises a catalyst positioned in the tube cavity and configured to convert oxygen gas and hydrogen gas to water.
Clause 13. The system of any of clauses 1-12, further comprising:
a first fluid conduit connecting the vessel port and the fluid source; and
a second fluid conduit connecting the vessel port and the discharge port.
Clause 14. The system of clause 13, wherein:
the first fluid conduit comprises a first flow valve configured to control fluid communication between the first volume and the fluid source; and
the second fluid conduit comprises a second flow valve configured to control fluid communication between the first volume and the discharge port.
Clause 15. The system of any of clauses 13-14, wherein:
the first fluid conduit comprises a first check valve configured to inhibit fluid flow from the vessel port to the fluid source; and
the second fluid conduit comprises a second check valve configured to inhibit fluid flow from the discharge port to the vessel port.
Clause 16. The system of any one of clauses 1-15, wherein the water source comprises at least one of water produced by the fuel cell, environmental water produced by condensation in a cavity of the fuel cell, and water produced in a secondary process of the fuel cell.
Clause 17. The system of any one of clauses 1-16, wherein the fluid discharge system is for a fuel cell and the fluid source comprises at least one of an anode outlet of the fuel cell, a cathode outlet of the fuel cell, and a water source outlet of the fuel cell.
Clause 18. A fuel cell system comprising:
a fuel cell; and
the fluid discharge system of clause 17 in fluid communication with the fuel cell.
Clause 19. A method for discharging byproducts produced during operation of a fuel cell, the method comprising:
enabling fluid communication between the fuel cell and a first volume of a vessel comprising an adjustable wall therein, the adjustable wall partially bounding the first volume;
moving the adjustable wall from a second position to a first position, thereby increasing a size of the first volume and drawing byproducts produced during operation of the fuel cell into the first volume from the fuel cell;
after the byproducts are drawn into the first volume, inhibiting fluid communication between the fuel cell and the first volume of the vessel; and
enabling fluid communication between the first volume and a discharge port and moving the adjustable wall from the first position to the second position thereby reducing the size of the first volume and expelling at least a portion of the byproducts from the first volume through the discharge port at a pressure greater than a reactant pressure of the fuel cell.
Clause 20. The method of clause 19, wherein the byproducts comprise at least one of oxygen gas, hydrogen gas, an impurity/inert gas, and water.
Clause 21. The method of any of clauses 19-20, wherein the byproducts are expelled through the discharge outlet into seawater having an environmental pressure greater than a reactant pressure of the fuel cell.
Clause 22. The method of any of clauses 19-21, wherein:
the adjustable wall forms a fluid tight seal between the first volume within the vessel partially bounded by a first side of the adjustable wall, and a second volume within the vessel partially bounded by a second side of the adjustable wall;
the first volume is in fluid communication with the inlet port and the discharge port via the vessel port;
introducing a non-compressible fluid to the second volume moves the adjustable wall within the vessel from the first position to the second position; and
removing at least a portion of the non-compressible fluid from the second volume moves the adjustable wall within the vessel from the second position to the first position.
Clause 23. The method of any of clauses 19-22, wherein the byproducts are produced during operation of a fuel cell and the fuel cell comprises the fluid source.
Clause 24. A method for discharging byproducts produced during operation of a fuel cell utilizing the system of clause 17.
Clause 25. A method for discharging byproducts produced during operation of a fuel cell, the method comprising:
enabling fluid communication between the fuel cell and the first volume of the vessel according to clause 17;
moving the adjustable wall from a second position to a first position, thereby increasing a size of the first volume and drawing byproducts produced during operation of the fuel cell into the first volume from the fuel cell;
after the byproducts are drawn into the first volume, inhibiting fluid communication between the fuel cell and the first volume of the vessel; and
enabling fluid communication between the first volume and a discharge port and moving the adjustable wall from the first position to the second position thereby reducing the size of the first volume and expelling at least a portion of the byproducts from the first volume through the discharge port at a pressure greater than a reactant pressure of the fuel cell.

In the present disclosure, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in the present disclosure is intended to include all higher numerical limitations subsumed therein. Accordingly, Applicant reserves the right to amend the present disclosure, including the claims, to expressly recite any sub-range subsumed within the ranges expressly recited. All such ranges are inherently described in the present disclosure.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

One skilled in the art will recognize that the herein described apparatus, systems, structures, methods, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A fluid discharge system, the system comprising:
an inlet port in fluid communication with a fluid source;
a discharge port; and
a vessel comprising a vessel port and an adjustable wall, wherein
the adjustable wall forms a fluid tight seal between a first volume within the vessel partially bounded by a first side of the adjustable wall, and a second volume of the vessel partially bounded by a second side of the adjustable wall, wherein the first volume fluidly communicates with the inlet port and the discharge port via the vessel port, and
the adjustable wall is configured to move between a first position and a second position within the vessel, wherein moving the adjustable wall from the second position to the first position within the vessel increases a size of the first volume and draws fluid through the inlet port into the first volume, and wherein moving the adjustable wall from the first position to the second position within the vessel decreases the size of the first volume and expels fluid through the discharge port from the first volume at a pressure greater than a pressure of the fluid source.

2. The system of claim 1, wherein the adjustable wall comprises at least one of a bellows, a diaphragm, a bladder, and a piston.

3. The system of claim 1, further comprising a hydraulic pump and a fluid reservoir, wherein the hydraulic pump configured to introduce a non-compressible fluid into the second volume of the vessel to move the adjustable wall from the first position to the second position, the hydraulic pump also configured to remove at least a portion of the non-compressible fluid from the second volume of the vessel to move the adjustable wall from the second position to the first position.

4. The system of claim 3, wherein the hydraulic pump is configured to provide the non-compressible fluid to the second volume at a pressure greater than a reactant pressure of the fuel cell.

5. The system of claim 3, wherein a pressure differential between fluid in the first volume and fluid in the second volume is no greater than 100 pounds per square inch absolute.

6. The system of claim 3, further comprising;
a sensor configured to measure at least one of the position of the adjustable wall and a non-compressible fluid level in the first volume; and
a controller in signal communication with the sensor and the hydraulic pump, the controller configured to adjust a state of the hydraulic pump based on the sensor.

7. The system of claim 1, further comprising a mechanical actuator configured to move the adjustable wall between the second position and the first position.

8. The system of claim 1, wherein, during operation, the vessel is oriented such that a portion of gas present in the first volume is expelled through the vessel port prior to expelling a portion of a non-compressible fluid in the first volume.

9. The system of claim 1, wherein a predetermined volume of a non-compressible fluid is maintained in the first volume during movement of the adjustable wall between the first position and the second position.

10. The system of claim 1, wherein the discharge port comprises an inverted tube defining a tube cavity and wherein, during operation of the system, the inverted tube is oriented such that a gas barrier is maintained in the tube cavity.

11. The system of claim 10, wherein at least one of a gas expelled from the first volume, a separate gas source in fluid communication with the discharge port, and a reactant positioned in the tube cavity is configured to adjust a pressure in the tube cavity to maintain the gas barrier during decent of the system into a sea and/or a hole.

12. The system of claim 10, wherein the inverted tube further comprises a catalyst positioned in the tube cavity and configured to convert oxygen gas and hydrogen gas to water.

13. The system of claim 1, further comprising:
a first fluid conduit connecting the vessel port and the fluid source; and
a second fluid conduit connecting the vessel port and the discharge port.

14. The system of claim 13, wherein:
the first fluid conduit comprises a first flow valve configured to control fluid communication between the first volume and the fluid source; and
the second fluid conduit comprises a second flow valve configured to control fluid communication between the first volume and the discharge port.

15. The system of claim 13, wherein:
the first fluid conduit comprises a first check valve configured to inhibit fluid flow from the vessel port to the fluid source; and
the second fluid conduit comprises a second check valve configured to inhibit fluid flow from the discharge port to the vessel port.

16. The system of claim 1, wherein the water source comprises at least one of water produced by the fuel cell, environmental water produced by condensation in a cavity of the fuel cell, and water produced in a secondary process of the fuel cell.

17. The system of claim 1, wherein the fluid discharge system is for a fuel cell and the fluid source comprises at least one of an anode outlet of the fuel cell, a cathode outlet of the fuel cell, and a water source outlet of the fuel cell.

18. A fuel cell system comprising:
a fuel cell; and
the fluid discharge system of claim 17 in fluid communication with the fuel cell.

19. A method for discharging byproducts into a high pressure environment, the method comprising:
enabling fluid communication between a fluid source and a first volume of a vessel comprising an adjustable wall therein, the adjustable wall partially bounding the first volume;
moving the adjustable wall from a second position to a first position, thereby increasing a size of the first volume and drawing byproducts into the first volume;
after the byproducts are drawn into the first volume, inhibiting fluid communication between the fluid source and the first volume of the vessel; and
enabling fluid communication between the first volume and a discharge port, and moving the adjustable wall from the first position to the second position thereby reducing the size of the first volume and expelling at least a portion of the byproducts from the first volume through the discharge port at a pressure greater than a pressure of the fluid source.

20. The method of claim 19, wherein the byproducts comprise at least one of oxygen gas, hydrogen gas, an impurity/inert gas, and water.

21. The method of claim 19, wherein the byproducts are expelled through the discharge outlet into seawater having an environmental pressure greater than a reactant pressure of the fuel cell.

22. The method of claim 19, wherein:
the adjustable wall forms a fluid tight seal between the first volume within the vessel partially bounded by a first side of the adjustable wall, and a second volume within the vessel partially bounded by a second side of the adjustable wall;
the first volume is in fluid communication with the inlet port and the discharge port via the vessel port;
introducing a non-compressible fluid to the second volume moves the adjustable wall within the vessel from the first position to the second position; and
removing at least a portion of the non-compressible fluid from the second volume moves the adjustable wall within the vessel from the second position to the first position.

23. The method of claim 19, wherein the byproducts are produced during operation of a fuel cell and the fuel cell comprises the fluid source.
